(19) United States
(12) Patent Application Publication
(10) Pub. No.: US 2026/0280466 A1
(43) Pub. Date: Sep. 17, 2026

(54) Integrated Induction Motor Monitoring and Overload Protection Device

(71) Applicant: ABB Schweiz AG, Baden (CH)

(72) Inventor: Timothy L. Brinkley, Fort Smith, AR (US)

(73) Assignee: ABB Schweiz AG, Baden (CH)

(21) Appl. No.: 19/077,671

(22) Filed: Mar. 12, 2025

(51) Int. Cl. H02P 29/024

(52) U.S. Cl. CPC H02P 29/027; H02P 2207/01

(57) ABSTRACT

A system includes a direct-on-line electric motor; a starting contact arranged in series with the electric motor and a power supply; at least one sensor configured to obtain an indication of a state of the electric motor; and a controller arranged in parallel to the electric motor and the power supply. The controller includes a receiver for the at least one sensor and is configured to: receive the indication via the at least one sensor receiver, determine, based on the indication, that a trip state has occurred, and open the starting contact based on determining that the trip state has occurred.

### FIELD

The present disclosure relates to electrical machines. In particular, the present disclosure relates to integrated induction motor monitoring and overload protection for direct on line applications.

### BACKGROUND

Electric motors can convert received electrical energy into mechanical energy. For example, an electric motor can receive an electric power supply and, through the interaction between the motor's magnetic field and electric current in a wire winding of a stator, generate force in the form of torque applied on the motor's rotor (e.g., shaft). To receive the power supply, electric motors can include a power circuit that connects a power line to the motor. The power circuit provides for the transmission of electricity through starter contacts, an overload relay, and then to electrical contactors of the motor. The motor receives electrical the electrical power from the contacts of the contactor. When the contactors are open, the electric motor is switched off (e.g., not operating), and when the contactors are closed, the electric motor is switched on (e.g., operating).

Electric motors can include an overload relay and a contactor. The overload relay can work with the contactor to start, stop, and protect the electric motor by preventing the motor from overheating due to excessive current. However, these overload relays and other monitoring devices are typically separate structures that are remotely mounted in an electrical cabinet outside of the electrical motors power circuit and are not integrated into the electric motor.

### SUMMARY

In a first aspect, the present disclosure provides a system including a direct-on-line electric motor; a starting contact arranged in series with the electric motor and a power supply; at least one sensor configured to obtain an indication of a state of the electric motor; and a controller arranged in parallel to the electric motor and the power supply. The controller includes a receiver for the at least one sensor and is configured to: receive the indication via the at least one sensor receiver, determine, based on the indication, that a trip state has occurred, and open the starting contact based on determining that the trip state has occurred.

Examples may include one of the following features, or any combination thereof. For instance, some examples of the system, the controller is further configured to close the starting contact based on: receiving a second indication; and determining, based on the second indication, that a closed state has occurred.

In some instances of the system, the controller further includes a battery. The battery is configured to receive power from the power supply when the starting contact is closed and the controller is configured to determine that the closed state has occurred using power received from the battery while the starting contact is open.

In some variations of the system, the controller further includes a memory including instructions which, when executed by one or more processors, are configured to facilitate: determining that the trip state has occurred based on the indication exceeding an associated threshold; and generating a trip signal. Opening the starting contact is further based on issuing, by the controller, the trip signal to a relay of the starting contact.

In some examples of the system, the controller further includes a wireless communication port, and the controller further includes a memory including instructions which, when executed by one or more processors, are configured to facilitate: receiving, from the wireless communication port, an instruction; and generating, based on the instruction, a close signal. Opening the starting contact is further based on issuing, by the controller, the close signal to the starting contact.

In some instances of the system, the at least one sensor includes a balanced three phase current sensor, wherein the balanced three phase current sensor includes a first current transformer for a first line of the power supply and a second current transformer for a second line of the power supply, and the indication is an indication of an overcurrent state.

In some variations of the system, the electric motor further includes a start coil, wherein the starting contact is arranged in series with the start coil of the electric motor and the power supply, and wherein the controller is further arranged in parallel to the starting contact coil.

In some examples of the system, the receiver further includes at least two ports each configured to receive a different type of indication of the state of the electric motor. The receiver is further configured to: generate a voltage barrier including a first side at a higher voltage output than a second side including a communication voltage; and convert at least one indication received at a first port of the at least ports on the first side to the communication voltage.

In some instances of the system, the controller further includes a relay, the relay including: an overloader including a contactor connecting a first overload terminal and a second overload terminal; a relay coil adjacent the contactor; and a transistor arranged in series between a power supply of the controller and the relay coil. Opening the starting contact is further based on issuing, by the controller, the trip signal to the transistor and closing the contactor based on a generated inductance of the relay coil.

In some variations of the system, the at least one sensor includes a temperature sensor, wherein the indication of the state of the electric motor includes an indication of the temperature of the motor, and wherein the motor includes the temperature sensor in at least one of: a stator of the motor, a rotor of the motor, or a bearing of the motor.

In a second aspect, a device for monitoring a direct-on-line electric motor includes a starting contact arranged in series with the electric motor and a power supply; at least one sensor configured to obtain an indication of a state of the electric motor; and a controller arranged in parallel to the electric motor and the power supply. The controller includes a receiver for the at least one sensor and is configured to: receive the indication via the at least one sensor receiver, determine, based on the indication, that a trip state has occurred, and open the starting contact based on determining that the trip state has occurred.

Examples may include one of the following features, or any combination thereof. For instance, some examples of the device, the controller is further configured to close the starting contact based on: receiving a second indication; and determining, based on the second indication, that a closed state has occurred.

In some variations of the device, the controller further includes a battery, wherein the battery is configured to receive power from the power supply when the starting contact is closed and wherein the controller is configured to determine that the closed state has occurred using power received from the battery while the starting contact is open.

In some examples of the device, the controller further includes a memory including instructions which, when executed by one or more processors, are configured to facilitate: determining that the trip state has occurred based on the indication exceeding an associated threshold; and generating a trip signal. Opening the starting contact is further based on issuing, by the controller, the trip signal to a relay of the starting contact.

In some instances of the device, the controller further includes a wireless communication port, and the controller further includes a memory including instructions which, when executed by one or more processors, are configured to facilitate: receiving, from the wireless communication port, an instruction; and generating, based on the instruction, a close signal. Opening the starting contact is further based on issuing, by the controller, the close signal to the starting contact.

In some variations of the device, the at least one sensor includes a balanced three phase current sensor, wherein the balanced three phase current sensor includes a first current transformer for a first line of the power supply and a second current transformer for a second line of the power supply. The indication is an indication of an overcurrent state.

In some examples of the device, the electric motor further includes a start coil, wherein the starting contact is arranged in series with the start coil of the electric motor and the power supply, and wherein the controller is further arranged in parallel to the starting contact.

In some instances of the device, the receiver further includes at least two ports each configured to receive a different type of indication of the state of the electric motor. The receiver is further configured to: generate a voltage barrier including a first side at a higher voltage output than a second side including a communication voltage; and convert at least one indication received at a first port of the at least ports on the first side to the communication voltage.

In some variations of the device, the controller further includes a relay. The relay includes: an overloader including a contactor connecting a first overload terminal and a second overload terminal; a relay coil adjacent the contactor; and a transistor arranged in series between a power supply of the controller and the relay coil. Opening the starting contact is further based on issuing, by the controller, the trip signal to the transistor and closing the contactor based on a generated inductance of the relay coil.

In some examples of the device, the at least one sensor includes a temperature sensor, wherein the indication of the state of the electric motor includes an indication of the temperature of the motor, and wherein the motor includes the temperature sensor in at least one of: a stator of the motor, a rotor of the motor, or a bearing of the motor.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an electric motor and an integrated induction motor monitoring and overload protection device according to one or more examples of the present disclosure;

FIG. 2 illustrates an integrated induction motor monitoring and overload protection system according to one or more examples of the present disclosure;

FIG. 3A illustrates a simplified circuit diagram of the power supply into the monitoring and overload protection device according to one or more examples of the present disclosure;

FIG. 3B illustrates a simplified circuit diagram of the power supply out of the monitoring and overload protection device according to one or more examples of the present disclosure;

FIG. 4 illustrates a simplified diagram of the monitoring and overload protection device according to one or more examples of the present disclosure;

FIG. 5 illustrates a simplified circuit diagram of the user serial communications circuit according to one or more examples of the present disclosure;

FIG. 6 illustrates a simplified circuit diagram of a relay according to one or more examples of the present disclosure;

FIG. 7 illustrates an example of an analog input isolation system according to one or more examples of the present disclosure;

FIG. 8 illustrates a temperature sensing and signal conditioning module according to one or more examples of the present disclosure;

FIG. 9A illustrates a voltage sensing and signal conditioning module according to one or more examples of the present disclosure;

FIG. 9B illustrates a current signal conditioning module according to one or more examples of the present disclosure;

FIG. 10 illustrates a simplified circuit diagram of a current transformer according to one or more examples of the present disclosure;

FIG. 11 illustrates a flyback power supply module according to one or more examples of the present disclosure;

FIG. 12 illustrates a simplified circuit diagram of an indicator light emitting diode (LED) according to one or more examples of the present disclosure;

FIG. 13 illustrates a simplified circuit diagram of a program debugging circuit according to one or more examples of the present disclosure;

FIG. 14 illustrates a battery management circuit module according to one or more examples of the present disclosure; and

FIG. 15 illustrates a block diagram of an exemplary processing system according to one or more examples of the present disclosure, which can be configured to perform any and all operations disclosed herein.

### DETAILED DESCRIPTION

Examples of the present application will now be described more fully hereinafter with reference to the accompanying FIGS., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

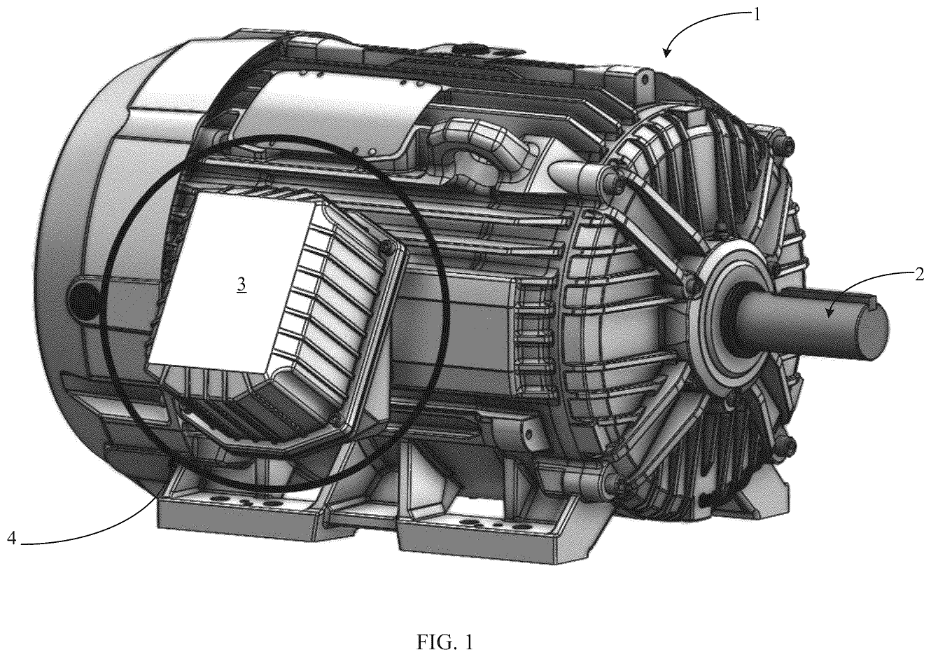

FIG. 1 shows an example of an electric motor according to one or more embodiments of the present disclosure. The electric motor can be configured for direct-on-line applications, where a direct-on-line motor refers to a motor that is started with full supply voltage to the motor terminals at a rated frequency. As a result, a method of reduced voltage or reduced frequency for starting the motor is not necessary. Electric motor 1 can utilize a three phase power supply (e.g., up to 10 Kw) for generating induction to drive the rotor 2 (e.g., generating an electric current in the rotor 2 which produces torque on the shaft of rotor 2). The box 3 enclosed by circle 4 can include a monitoring and overload protection device that is integrated into the electric motor. The monitoring and overload protection device can be housed in box 3, and be integrated into the power circuit of the electric motor. The device housed in box 3 can provide many functionalities, such as measuring motor phase currents, phase voltages, winding temperature, bearing temperature, and thermostat states. The motor can also have an integrated motor overload with programmable trip class a contact (e.g., dry contact) can be used to trip the motor starting contactor. The device can also have serial communications (e.g., over RS-485 or an Ethernet or other internet protocol) and wireless connectivity and communications (e.g., over WiFi and Bluetooth).

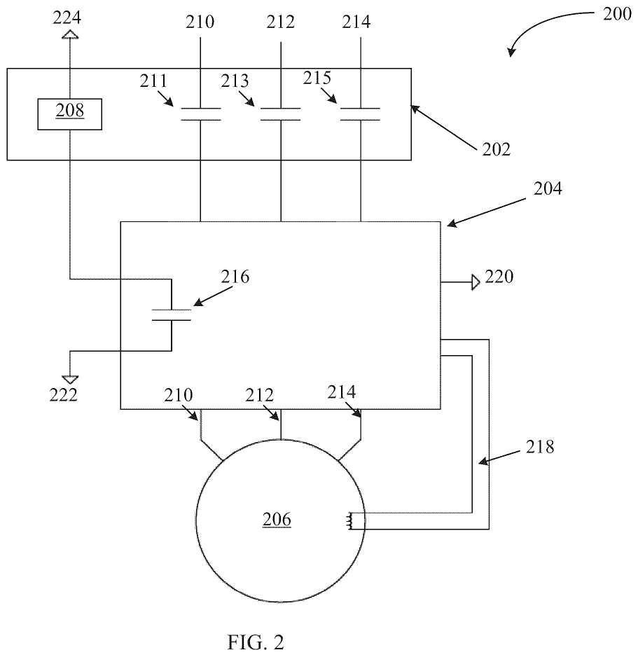

FIG. 2 provides an example of an integrated induction motor monitoring and overload protection system according to one or more examples of the present disclosure. The system 200 includes a power supply 202, a monitoring and overload device 204 (e.g., including a microcontroller), and the electric motor 206. The power supply 202 includes a start coil 208 and a three phase alternating current (AC) power input with power lines 210, 212, 214 and contactors 211, 213, 215 for each power line. When the start coil 208 on the contactors 211, 213, 215 is energized, an electromagnetic field is generated that pulls the contactors 211, 213, 215 closed and transmits line power over power lines 210, 212, 214. The power supply 202 can provide power to the monitoring and overload device 204 in parallel to and from the power lines 210, 212, and 214 (e.g., at a lower voltage). For example, one or more of the power lines 210, 212, 214 (e.g., a circuit in parallel to and powered by one or more of the power lines 210, 212, 214) can power a flyback circuit that can rectify the input voltage and/or generate one or more direct current (DC) voltage supplies.

The power lines 210, 212, 214 run to the electric motor 206 and, when current is running through the power lines 210, 212, 214, power the electric motor 206. However, a contactor 216 (e.g., ignition contact, starting contact) for the start coil 208 is interposed between the electric motor 206 and the power supply 202, in series to the device 204. The device 204 can control the contactor 216 to open or close the contactor 216, which deenergizes or energizes the start coil 208 of the start line (e.g., from ground 222 to voltage out 224), and thereby switches off or on (respectively) the power lines 210, 212, 214 to the electric motor 206. Additionally, and/or alternatively, the microcontroller 204 can provide serial communications 220 to user side components (e.g., wireless communication protocols) to receive control signals, including control signals to open and/or close the contactor 216 and/or adjust the conditions (e.g., thresholds, set points) for operating the contactor 216.

The device 204 can operate the contactor 216 based on one or more functionalities (e.g., temperature sensing, automation process control, overcurrent, bearing failure). For example, resistance temperature detectors (RTDs) for the electric motor 206 can provide temperature data 218 to the device 20, and the device 204 can determine when an overheating event occurs (e.g., by comparison to one or more thresholds, predictive rate of increase analytics, fault data logs). Based on determining that an overheating event has occurred, the device 204 can open the contactor 216 can shut off power to the electric motor 206. Additionally, and/or alternatively, the device 204 can determine that a start event occurs (e.g., motor 206 has cooled enough, start command wirelessly received from process control) and switch contactor 216 closed to energize the start coil 208.

The device 204 can include programmable parameters for any measurement and/or sensor data received, and/or determination performed (e.g., a rated current, rated voltage, efficiency, overload trip class, and/or temperature limit) for the electric motor 206 that the system is integrated into and monitoring. Upon determining that one or more of the parameters is violated (e.g., a trip state has occurred due to exceeding rated current) based on the received indication (e.g., sensor data or received control signals from building/process automation), the device 204 can trip the contactor 216 and effectively power off the electric motor 206. For example, when a phase of the three phase power supply drops out, the motor 206 may continue to run but is likely to overheat and/or run inefficiently. Upon determining that a phase has dropped out, the device 204 can trip the contactor 206 (e.g., based on a programmable parameter directing the device 204 to do so) and power off the motor 206. Additionally, and/or alternatively, the device 204 can have a motor overload parameter, where the parameters allows a rated overcurrent (e.g., 600%) for a defined amount of time (e.g., 1 to 6 seconds) or a determined time based on the amount of overcurrent and/or temperature increase (e.g., 5 minutes for 120% overcurrent) before tripping. The device 204 can be further configured to receive a second indication (e.g., motor has cooled, third phase restored), determine that a closed state has occurred based thereon, and closed the starting contact based on the closed state occurring. Additionally, and/or alternatively, the device 204 can communicate with the building/process automation and report the current, phase voltage, and operating temperatures of the electric motor. The device can determine the power factor and provide the determined power factor report to building/process automation.

For example, the induction motor monitoring and overload protection system 200 can be integrated into the electric motor (e.g., into the cast iron housing) and is highly customizable to work with multiple different monitoring services. For instance, the system 200 can be adapted to include designated, different, and/or redundant hardware components for each type of measurement (e.g., current, voltage, temperature, vibration, mechanical integrity), and can be adapted to provide different and/or redundant communication protocols for the hardware components (e.g., analog, digital). Moreover, the system 200 can be adapted to provide different components for the same measurement (e.g., an RTD and a thermocouple for temperature indications). The system 200 can provide (e.g., as the device 204) a single printed circuit board (PCB) including all the communication components for receiving sensor and/or measurement data and the analytical components for determining event conditions (e.g., trip state occurrence, start event) based on the received sensor and/or measurement data. For example, a single PCB can include the RS485 circuit for communications, the relay circuit, terminals for the current transformer, a power supply circuit, LEDs, program bug and debugging, battery management circuit, and receivers for RTD data, while the actual RTD can be embedded in various locations of the motor. As a result, one component can serve a variety of roles and purposes (e.g., voltage, current, and temperature sensing) and be easily integrated into an electric motor.

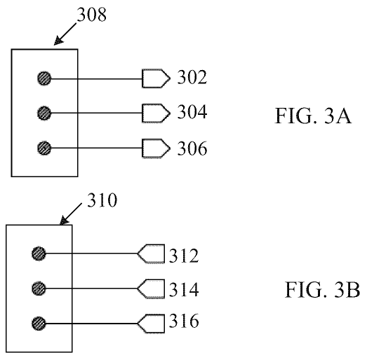

FIG. 3A shows a power supply into the monitoring and overload protection device according to one or more examples of the present disclosure. The device 308 (e.g., microcontroller 204 of FIG. 2) includes three connectors 302, 304, and 306 (e.g., the connectors 216, 218, 220). The connector 302 can receive a first phase of the power supply, the connector 304 can receive a second phase of the power supply, and the connector 306 can receive a third phase of the power supply. The connectors 302, 304, and 306 together can receive input power from the contactor of the power supply. FIG. 3B shows a power supply out of the monitoring and overload protection device according to one or more examples of the present disclosure. The device 310 (e.g., microcontroller 204 of FIG. 2) includes three outputs 312, 314, and 316. The output 312 can provide a first phase of power to the electric motor, the connector 314 can provide a second phase of power to the electric motor, and the connector 316 can provide a third phase of power to the electric motor. The connectors 302, 304, and 306 together can provide power to the terminals of the electric motor. Accordingly, devices 308 and 310 of FIGS. 3A and 3B can receive and provide electrical power from the power supply to the motor via the controller (e.g., microcontroller 204).

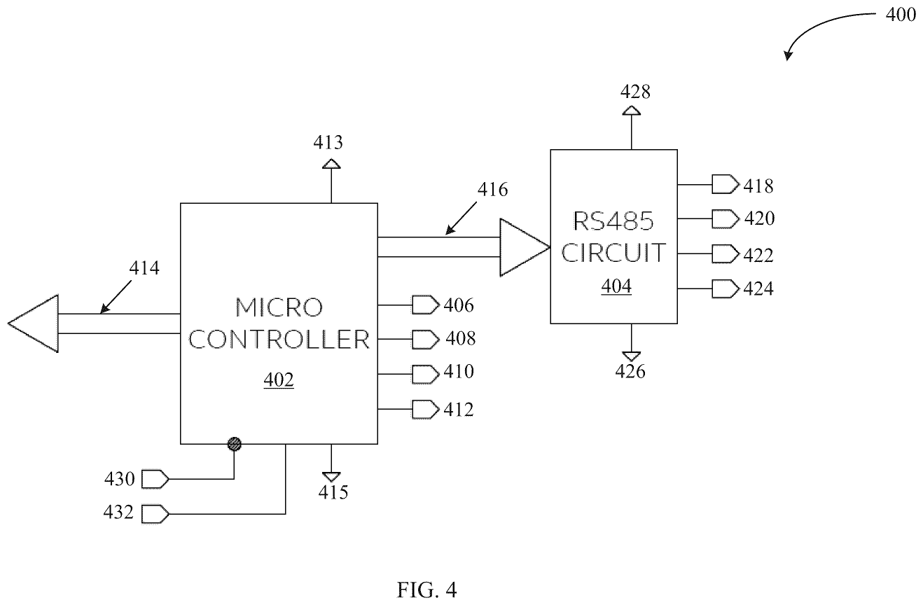

FIG. 4 shows a system 400 including a controller 402 and a user serial communications circuit 404 (e.g., an RS485 circuit) according to one or more embodiments of the present disclosure. The system 400 depicts a microcontroller-based communication system that interfaces with the serial communication circuit 404, indicator light emitting diodes (LEDs) 406, 408, 410, a communication bus 414, and a relay 412. The controller 402 can include the central processing unit of the circuit (e.g., on a circuit board), can include firmware for receiving component data (e.g., from thermal sensors, current and voltage measurements, and serial communication protocols), and can provide overload protection services. For example, the controller 402 can include a programmable set point for temperature measurements and issue a trip a signal to a contactor (e.g., of relay 412) when the temperature data indicates the motor has exceed a temperature set point. Additionally, and/or alternatively, the controller 402 can relay the component data to process automation devices and/or components (e.g., Bluetooth and Wi-Fi communications to a central server and/or serial communications to memory).

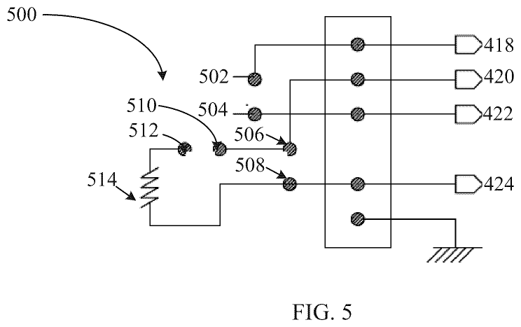

The controller 402 can also be connected to (e.g., send and receive signals to/from) the user serial communications circuit 404 using a Universal Asynchronous Receiver/Transmitter (UART) 416 and a user service routine (USR) power supply (e.g., from USR ground 426 to USR out 428). The user serial communications circuit can then convert the UART 416 signals into further signals (e.g., RS-485 differential signals) and provide TX+ 418/TX− 420 (transmit signals) and RX+ 422/RX− 424 (receive signals) for differential communication. For example, FIG. 5 depicts a more detailed circuit diagram 500 of the user serial communications circuit (e.g., for wired communications and/or separate from the machine communications). A pair of first jumper pins 502, 504 on the receive circuit side are split between the TX+ 418 and RX+422 signal ports, a pair of second jumper pins 506, 508 are split between the TX− 420 and RX− 424 ports, and a third pair of jumper pins 510, 512 are split between the TX− 420 port on the transmit side and resistor 514 (e.g., 120 Ohms) on the RX− 424 port to provide an impedance for the user serial communications circuit. The user serial communications circuit can be wired upon installation of the monitoring unit, and utilize many different types of communications protocols (e.g., MODBUS, PROFIBUS, building automation and control networks (BACnet)).

Additionally, and/or alternatively, the controller 402 can utilize a relay 412. The relay can be configured to control the ignition contact for the start coil (e.g. contactor 216), thereby allowing the incoming power supply to be switched off and/or on. Accordingly, the microcontroller 402 can operate the relay 412 to switch the motor's contactors to open or closed (e.g., off or on, respectively). For example, the controller 402 can operate the relay 412 to open the contactors and switch the motor off based on logic conditions, e.g., when the temperature or current exceeds a threshold (e.g., a set point or range).

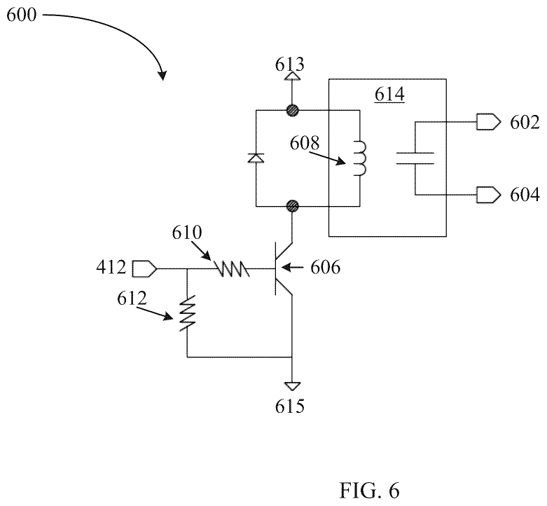

For example, FIG. 6 depicts a schematic representation of a relay circuit 600 of relay 412 according to one or more examples of the present disclosure. The relay circuit 600 provides the digital (e.g., binary) output of the controller 402, and includes two output terminals 602 and 604 that are configured to switch a corresponding contact for the motor's power supply to open or closed. The terminals can close when the transistor (e.g., transistor juncture 606) is turned on, causing current to flow to the relay coil 608, which induces a short of the output terminals 602, 604 and closes the start contactors and/or flows current to the motor contactor that causes the motor contactor to close. For instance, the relay circuit 600 can be controlled using one or more relay signals received at relay port 412 (e.g., low power signals issued by controller 402), and based on the relay signal, the relay circuit 600 can cause an interruption and/or connection in the electric motor's (e.g., electric motor 206) power supply. For instance, controller 402 can issue the relay signal, and the relay signal then traverses resistor 610 to the transistor juncture 606 at the power supply circuit of the relay circuit 600, where the power supply circuit provides power to the relay coil 608 in the +USR out 613 direction and a common ground reference for the circuit at USR ground 615. The resistor 610 can be provided to help limit the current of the connection to the microcontroller 402, and the pulldown resistor 612 can be provided to help avoid floating voltages and/or false triggering (e.g., due to noise) of the relay. For instance, the resistor 610 can provide a resistance that the relay signal must overcome to activate the transistor 606, and if not, directs the current through the pulldown resistor 612 (e.g., a weaker resistance) to ground 615. Then, based on receiving the relay signal, the coil 608 of the relay is energized by the current of the relay signal flowing through it, causing an internal switch of the relay 614 to change state. The internal switch of the relay 614 can include and/or be connected to the two output terminals 602, 604 (e.g., overload terminals), and the internal switch can be configured to switch the contacts of these terminals 602, 604 from closed to open or open to closed. In this way, the relay circuit 600 can be configured to provide a motor overloader integrated into the electric motor rather than separately provided.

Additionally, and/or alternatively, the output terminals 602, 604 can be configured at a default state (e.g., open), and the relay 614 can switch the output terminals off of their default state (e.g., to closed), and upon the relay coil de-energizing, return the output terminals to their default state. Additionally, and/or alternatively, the coil 608 can be paired with a flyback diode 616 connected across from (e.g., in parallel to) the relay coil 608 to protect the circuit from voltage spikes (e.g., back electromotive force (EMF)) generated when the relay coil 608 is de-energized. Accordingly, relay circuit 600 can provide a more reliable protection circuit for overload and fault condition monitoring that can be easily integrated into an electric motor.

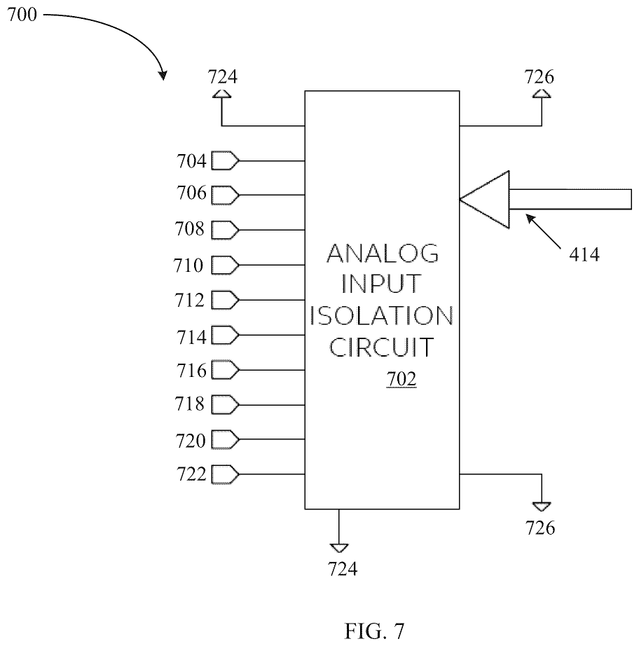

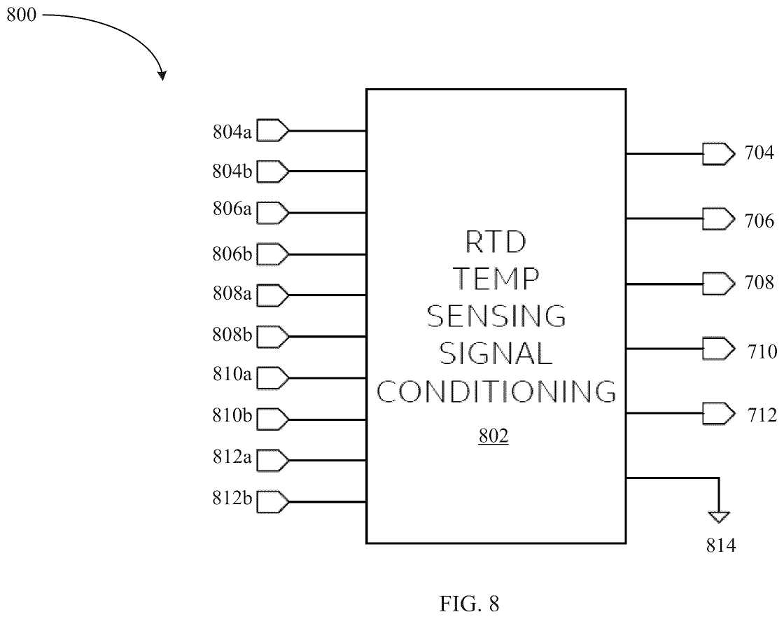

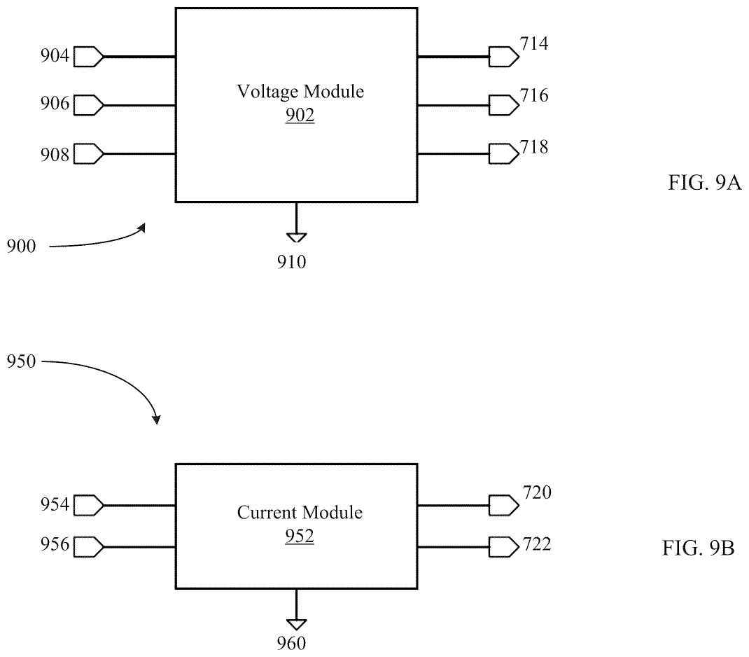

Additionally, and/or alternatively, the controller 402 can utilize (e.g., send and receive signals to/from) a serial periphery interface (SPI) bus 414, which is an interface bus commonly used to send data between microcontrollers and small peripherals such as shift registers, sensors, and secure digital (SD) cards. For example, the controller 402 can use the SPI bus 414 to interface with an analog input isolation system 700 for external devices such as temperature sensing signal conditioning, voltage sensing and signal conditioning, and current signal conditioning. FIG. 7 provides an example of an analog input isolation system 700 according to one or more examples of the present disclosure. The analog input isolation system 700 includes an analog input isolation circuit 702 configured to interface multiple analog input signals with a digital processing system (e.g., SPI bus 414) while providing electrical isolation between the components. For instance, the analog input isolation circuit 702 can receive the incoming amplified RTD signals 704, 706, 708, 710, 712 (further described below with reference to FIG. 8), the incoming voltage conditioned signals 714, 716, 718 (further described below with reference to FIG. 9A), and the incoming current conditioned signals 720, 722 (further described below with reference to FIG. 9B), and electrically isolate each signal (e.g., to reduce electrical noise, ground loops, and/or interference in the signals). The circuit 702 can also process the incoming analog signals (e.g., amplified RTD signals 704, 706, 708, 710, 712, voltage conditioned signals 714, 716, 718, and current conditioned signals 720, 722) and convert them into a digital format for communication over the SPI bus 414. The circuit 702 can be powered by a high voltage side power supply 724 (e.g., +15V and −15V), generate a voltage barrier between the input side and the output side (e.g., SPI bus), and supply power to the user side communications via USR via the low voltage side power supply 726 of the voltage barrier. Additionally, and/or alternatively, the analog input isolation system 700 can be adapted to accommodate different hardware components for different measurements while still providing the protection and isolation for the user side and measuring the input voltage and/or temperature data that the sensors are collecting by measuring the analog signal outputs.

FIG. 8 depicts an RTD temperature sensing and signal conditioning module 800 according to one or more examples of the present disclosure that can provide (e.g., generate) the amplified RTD signals 704, 706, 708, 710, 712. For example, the RTD module 802 can receive one or more RTD sensor (e.g., thermostat) inputs 804a, 804b, 806a, 806, 808a, 808b, 810a, 810b, 812a, 812b. These RTD sensors can include precision, wire-wound resistors with a known temperature resistance characteristic, can be wired into a specific type of circuit (e.g., a Wheatstone bridge), and/or positioned at multiple points of the electric motor (e.g., stator, rotor, bearings, surface, coolant lines, power supply line, starter contacts). These RTD sensors can sense and/or measure the temperature of the assigned locations and provide the data to the RTD module 1202. The RTD module 1202 can then filter and/or amplify any data received from the sensor inputs, and output an amplified RTD sensor signal for each RTD sensor input. Additionally, and/or alternatively, each RTD sensor input can include a pair of RTD sensor inputs (e.g., power RTD signal 804a and neutral RTD signal 804b), and output an amplified RTD sensor signal (e.g., amplified RTD sensor signal 712) for each paired RTD sensor input 804a, 804b. The RTD sensors and RTD module 1202 can be provided on the input power side (e.g., high voltage side of the voltage barrier) of the analog input isolation system 700, while the amplified signals are provided on the low voltage side (e.g., along with the voltage reference 814).

FIG. 9A depicts a voltage sensing and signal conditioning module 900 according to one or more examples of the present disclosure that can provide the voltage conditioned signals 714, 716, 718. The voltage module 902 (e.g., including a voltage divider arrangement) receives input voltage from the three phase power supply, conditions the input voltages, and outputs conditioned line voltage signals 714, 716, 718 corresponding to each input voltage 904, 906, 908 (e.g., each phase of the power supply) for further processing (e.g., to the analog input isolation circuit 1400). For example, the conditioning may include filtering, scaling, and isolation for safe and accurate signal transmission. These conditioned line voltage signals 714, 716, 718 can then form a basis of the signals the controller 402 ultimately receives when determining voltage levels. Additionally, the voltage module can include a neutral connection 910 as a 0 voltage reference point for the voltage module 902.

FIG. 9B depicts a current signal conditioning module 950 according to one or more examples of the present disclosure that can provide the current conditioned signals 720, 722. The current module 952 receives current inputs 954 and 956 (e.g., the outputs I1 and I2 of current transformer 1000), conditions the inputs, and outputs conditioned current signals 720, 722 corresponding to each current input 952 and 954 for further processing (e.g., to the analog input isolation circuit 1400). For example, the conditioning may include amplification, isolation, and filtering for further use in monitoring or control circuits. These conditioned current signals 729, 722 can then form a basis of the signals the controller 402 ultimately receives when determining current values (e.g., for detecting overcurrent conditions). Additionally, the current module 952 can include a neutral connection 960 as a 0 voltage reference point for the current module 960.

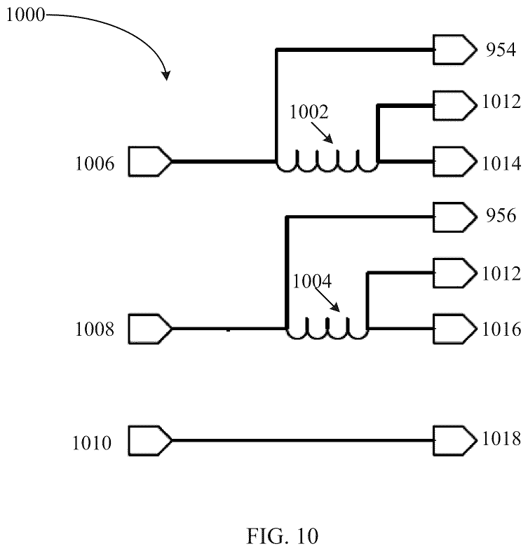

FIG. 10 depicts a transformer circuit 1000 according to an example of the present disclosure that can provide the line current signals I1 and I2 of the current signal conditioning 950 and the power supply out of the monitoring device. The transformer circuit 1000 includes two current transformers (CT) 1002 and 1004 positioned with the respective phase wire input 1006 and 1008 (e.g., received at connectors 302 and 304) running through the transformers 1002 and 1004, wherein each current transformer 1002 and 1004 provides a magnetic core (e.g., an iron core toroid) with windings wound around the core. The according to the step-down factor of the current transformer 1002 and 1004, the transformers 1002 and 1004 measure the current of the three phase power supply including wires 1006, 1008, and 1010 (e.g., for a balanced three phase power supply, the amperage sum of the first phase wire 1006 and second phase wire 1008 represents the amperage sum of the power supply). Each current transformer 1002, 1004 is then connected to the current signal conditioning module 950 via connections 954 and 956, respectively, and a neutral reference voltage source 1012. The first phase wire 1006 (e.g., power line 210) continues through the current transformer 1002 to the electric motor (e.g., motor 206) via path 1014, the second phase wire 1008 (e.g., power line 212) continues through the current transformer 1004 to the electric motor via path 1016, and the third phase wire 1010 (e.g., power line 214) continues to the electric motor without a current transformer via path 1018.

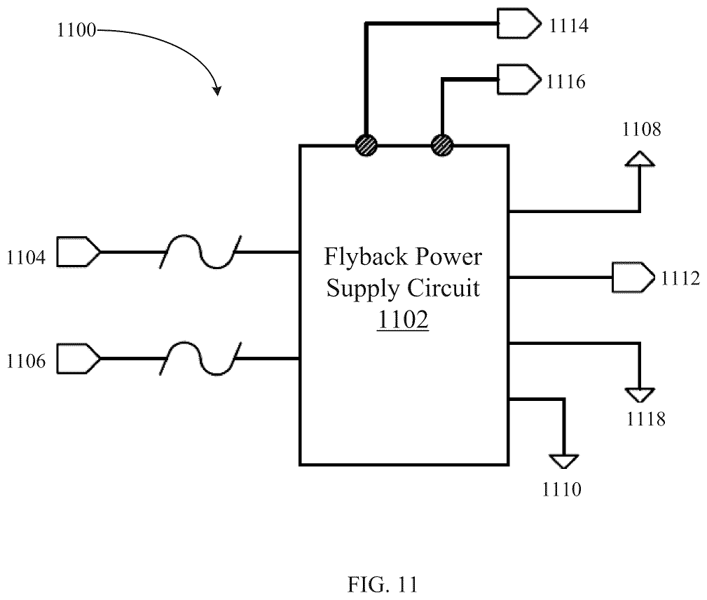

Additionally, and/or alternatively, the controller 402 can provide a +USR output 413 and a USR ground 415, which is a voltage that is created by the microcontroller power supply that is referenced to the user's serial communications (e.g., RS485). The plus USR 413 can be a floating supply generated by the controller 402 (e.g., using a flyback power supply circuit 1100). The +USR output can used anywhere there is a user connection (e.g., a connection to the control system). For example, FIG. 11 depicts a wide input flyback power supply circuit 1100 according to one or more examples of the present disclosure. The circuit 1100 can convert an AC and/or wide-range DC input into multiple regulated DC voltage outputs. For instance, flyback circuit 1102 can be a switched-mode power supply (SMPS) that can step up or step down voltage that accepts a wide range of input voltages (AC or DC) and provide multiple regulated outputs. Flyback converter 1102 can receive isolated and/or filtered inputs 1104 and 1106 (e.g., via a connection from two lines of the three phase power supply). The flyback converter 1102 can generate and isolate many different voltage supplies from the received inputs 1104 and 1006, such as high voltage output lines 1108 and 1110 (e.g., +15V and −15V) for analog applications, a low voltage output line 1112 (e.g., +3.3V for logic and microcontrollers (e.g., controller 402)), +USR and GND_USR output lines 1114 and 1116, and/or a voltage neutral reference 1118 for the outputs.

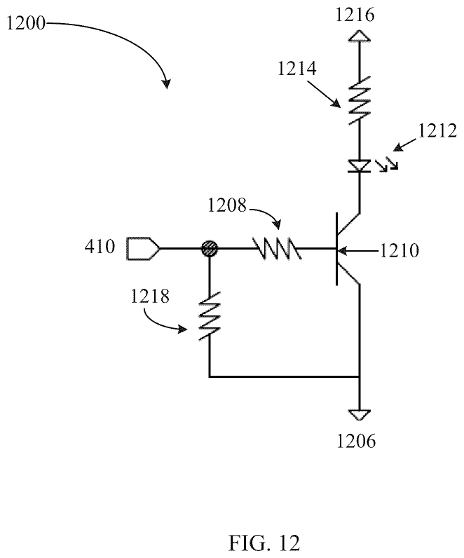

Additionally, and/or alternatively, the controller 402 can utilize one or more indicator LED circuits 1200, including a yellow, green, and/or red LED. The one or more LEDs can be connected to the controller 402 for visual status indication, where the controller 402 can control the one or more LEDs to indicate any programmable status alone or in combination (e.g., relay status, communication status, contactor status (open, closed, fault), and/or fault conditions). For example, FIG. 12 depicts an example of an indicator LED circuit 1200 that can be operated by controller 402 (e.g., via indicator LED port 406). The indicator LED port 480 can receive a control signal from the controller 402 (e.g., to turn the LED on or off, flicker, morse code) that traverses a series resistor 1208 and to the transistor 1210 (pulldown resistor 1218 being provided for unintentional current flows to indicator LED port 410 that exit the circuit 1200 via voltage reference 1206). The current of the control signal switches the transistor 1210, diverts the current across the LED 1212 (causing the LED to emit light) and through the resistor 1214 +USR connection 1216, thereby turning on the LED 1212.

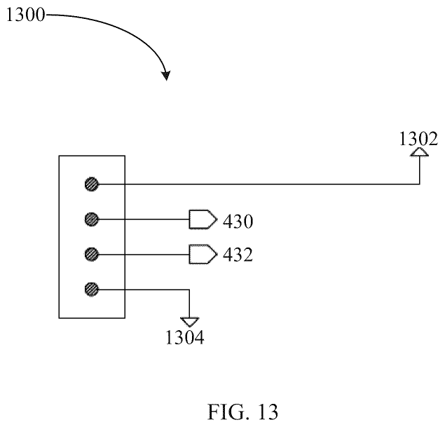

Additionally, and/or alternatively, the controller 402 can utilize programming pins 430, 432. For example, controller 402 can use the programming pins for firmware updates and/or bugging/debugging tools using an external programmer or debugging tool. For instance, FIG. 13 depicts a program debugging circuit 1300 according to one or more aspects of the present disclosure. The program debugging circuit 1300 can utilize a pin debugging method powered by a USR power supply (e.g., +USR out 1302 and USR ground 1304), where a controller (e.g., controller 402) can set pin 430 at a specified point of a code (e.g., script, process, function) and access the specific point as desired. Additionally, the controller can determine whether the code is active, the repetition rate of the code, and when the pin is set at the start of a process and reset at the end of the process, the process time length. Pin 432 can be set as a redundant pin and/or at a different specific point of the code. Additionally, and/or alternatively, debugging circuit 1300 may utilize other forms of debugging, such as in-circuit emulators (ICE), in-circuit debug (ICD), visual indications for 430 and 432 (e.g., similar to the indicator LEDS) and/or a level translator chip via the UART1 connection.

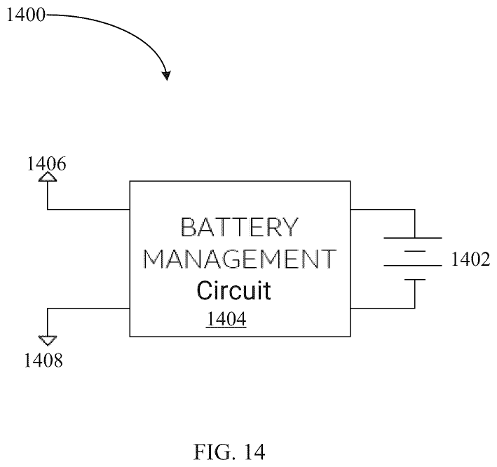

Additionally, and/or alternatively, the controller 402 can include a battery management module 1400 that can power the controller 402 when the electric motor is disconnected from the power supply (e.g., power lines 210, 212, 214). For example, FIG. 14 depicts a battery management module 1400 including a battery management circuit 1404 that can charge a battery 1402 (e.g., 3.7V) from a USR power supply (e.g., USR out 1406 and USR ground 1408) when the controller 402 is receiving power from the power supply. When power is removed (e.g., power lines 210, 212, 214 are not carrying current to the electric motor 206), the battery 1402 of the battery management circuit 1400 can still provide power for the controller 402 to send and/or receive communications. For example, when the controller 402 trips the contactor (e.g., based on determining the motor has overheated), building automation processes can identify the trip and delay restarting of the electric motor until the motor gets down to a defined temperature (e.g., for immediate restart or maintenance and/or investigation). While no longer receiving power directly from the power supply, the controller 402 can draw operating power from the batter management circuit 1404 and provide real time temperature measurements (e.g., to store in memory or provide to building automation). The battery 1402 and battery management circuit 1404 can be small enough to be implanted into the PCB of a controller 402.

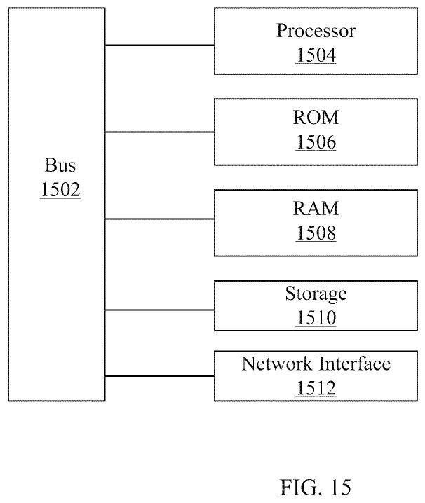

FIG. 15 is a block diagram of an exemplary system or device 1500 within the environment 200 such as the device 204. The system 1500 includes a processor 1504, such as a central processing unit (CPU), and/or logic, which executes computer executable instructions for performing the functions, processes, and/or methods described herein. In some examples, the computer executable instructions are locally stored and accessed from a non-transitory computer readable medium, such as storage 1510, which may be a hard drive or flash drive. Read Only Memory (ROM) 1506 includes computer executable instructions for initializing the processor 1504, while the random-access memory (RAM) 1508 is the main memory for loading and processing instructions executed by the processor 1504. The network interface 1512 may connect to a wired network or cellular network and to a local area network or wide area network. The system 1500 may also include a bus 1502 that connects the processor 1504, ROM 1506, RAM 1508, storage 1510, and/or the network interface 1512. The components within the system 1500 may use the bus 1502 to communicate with each other. The components within the system 1500 are merely exemplary and might not be inclusive of every component within the device 204. Additionally, and/or alternatively, the system 1500 may further include components that might not be included within every entity of environment 1500. For instance, in some examples, the device 204 might not include a network interface 1512.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A system, comprising:
a direct-on-line electric motor;
a starting contact arranged in series with the electric motor and a power supply;
at least one sensor configured to obtain an indication of a state of the electric motor; and
a controller arranged in parallel to the electric motor and the power supply, the controller comprising a receiver for the at least one sensor and configured to:
receive the indication via the at least one sensor receiver,
determine, based on the indication, that a trip state has occurred, and
open the starting contact based on determining that the trip state has occurred.

2. The system of claim 1, wherein the controller is further configured to close the starting contact based on:
receiving a second indication; and
determining, based on the second indication, that a closed state has occurred.

3. The system of claim 2, wherein the controller further comprises a battery, wherein the battery is configured to receive power from the power supply when the starting contact is closed and wherein the controller is configured to determine that the closed state has occurred using power received from the battery while the starting contact is open.

4. The system of claim 1, wherein the controller further comprises a memory comprising instructions which, when executed by one or more processors, are configured to facilitate:
determining that the trip state has occurred based on the indication exceeding an associated threshold; and
generating a trip signal,
wherein opening the starting contact is further based on issuing, by the controller, the trip signal to a relay of the starting contact.

5. The system of claim 1, wherein the controller further comprises a wireless communication port, and wherein the controller further comprises a memory comprising instructions which, when executed by one or more processors, are configured to facilitate:
receiving, from the wireless communication port, an instruction; and
generating, based on the instruction, a close signal,
wherein opening the starting contact is further based on issuing, by the controller, the close signal to the starting contact.

6. The system of claim 1, wherein the at least one sensor comprises a balanced three phase current sensor, wherein the balanced three phase current sensor comprises a first current transformer for a first line of the power supply and a second current transformer for a second line of the power supply, and wherein the indication is an indication of an overcurrent state.

7. The system of claim 1, wherein the electric motor further comprises a start coil, wherein the starting contact is arranged in series with the start coil of the electric motor and the power supply, and wherein the controller is further arranged in parallel to the starting contact coil.

8. The system of claim 1, wherein the receiver further comprises at least two ports each configured to receive a different type of indication of the state of the electric motor, wherein the receiver is further configured to:
generate a voltage barrier comprising a first side at a higher voltage output than a second side comprising a communication voltage; and
convert at least one indication received at a first port of the at least ports on the first side to the communication voltage.

9. The system of claim 1, wherein the controller further comprises a relay, the relay comprising:
an overloader comprising a contactor connecting a first overload terminal and a second overload terminal;
a relay coil adjacent the contactor; and
a transistor arranged in series between a power supply of the controller and the relay coil,
wherein opening the starting contact is further based on issuing, by the controller, the trip signal to the transistor and closing the contactor based on a generated inductance of the relay coil.

10. The system of claim 1, wherein the at least one sensor comprises a temperature sensor, wherein the indication of the state of the electric motor comprises an indication of the temperature of the motor, and wherein the motor comprises the temperature sensor in at least one of: a stator of the motor, a rotor of the motor, or a bearing of the motor.

11. A device for monitoring a direct-on-line electric motor, the device comprising:
a starting contact arranged in series with the electric motor and a power supply;
at least one sensor configured to obtain an indication of a state of the electric motor; and
a controller arranged in parallel to the electric motor and the power supply, the controller comprising a receiver for the at least one sensor and configured to:
receive the indication via the at least one sensor receiver,
determine, based on the indication, that a trip state has occurred, and
open the starting contact based on determining that the trip state has occurred.

12. The device of claim 11, wherein the controller is further configured to close the starting contact based on:
receiving a second indication; and
determining, based on the second indication, that a closed state has occurred.

13. The device of claim 12, wherein the controller further comprises a battery, wherein the battery is configured to receive power from the power supply when the starting contact is closed and wherein the controller is configured to determine that the closed state has occurred using power received from the battery while the starting contact is open.

14. The device of claim 11, wherein the controller further comprises a memory comprising instructions which, when executed by one or more processors, are configured to facilitate:
determining that the trip state has occurred based on the indication exceeding an associated threshold; and
generating a trip signal,
wherein opening the starting contact is further based on issuing, by the controller, the trip signal to a relay of the starting contact.

15. The device of claim 11, wherein the controller further comprises a wireless communication port, and wherein the controller further comprises a memory comprising instructions which, when executed by one or more processors, are configured to facilitate:
receiving, from the wireless communication port, an instruction; and
generating, based on the instruction, a close signal,
wherein opening the starting contact is further based on issuing, by the controller, the close signal to the starting contact.

16. The device of claim 11, wherein the at least one sensor comprises a balanced three phase current sensor, wherein the balanced three phase current sensor comprises a first current transformer for a first line of the power supply and a second current transformer for a second line of the power supply, and wherein the indication is an indication of an overcurrent state.

17. The device of claim 11, wherein the electric motor further comprises a start coil, wherein the starting contact is arranged in series with the start coil of the electric motor and the power supply, and wherein the controller is further arranged in parallel to the starting contact.

18. The device of claim 11, wherein the receiver further comprises at least two ports each configured to receive a different type of indication of the state of the electric motor, wherein the receiver is further configured to:
generate a voltage barrier comprising a first side at a higher voltage output than a second side comprising a communication voltage; and
convert at least one indication received at a first port of the at least ports on the first side to the communication voltage.

19. The device of claim 11, wherein the controller further comprises a relay, the relay comprising:
an overloader comprising a contactor connecting a first overload terminal and a second overload terminal;
a relay coil adjacent the contactor; and
a transistor arranged in series between a power supply of the controller and the relay coil,
wherein opening the starting contact is further based on issuing, by the controller, the trip signal to the transistor and closing the contactor based on a generated inductance of the relay coil.

20. The device of claim 11, wherein the at least one sensor comprises a temperature sensor, wherein the indication of the state of the electric motor comprises an indication of the temperature of the motor, and wherein the motor comprises the temperature sensor in at least one of: a stator of the motor, a rotor of the motor, or a bearing of the motor.
